(19) United States
(12) Patent Application Publication
(10) Pub. No.: US 2013/0013512 A1
(43) Pub. Date: Jan. 10, 2013

(54) SOFTWARE DEVELOPMENT KIT BASED FRAUD MITIGATION

(75) Inventors: Kennard Cloud, Phoenix, AZ (US); Marcel Leyva, Chandler, AZ (US); Chanderpreet Singh Duggal, Phoenix, AZ (US); Kristin Gomes, Fenton, MO (US); Charles Kimes, Scottsdale, AZ (US)

(73) Assignee: American Express Travel Related Services Company, Inc., New York, NY (US)

(21) Appl. No.: 13/620,054

(22) Filed: Sep. 14, 2012

Related U.S. Application Data
(63) Continuation-in-part of application No. 12/874,063, filed on Sep. 1, 2010.

(51) Int. Cl. G06Q 20/40

(52) U.S. Cl. 705/44

(57) ABSTRACT

A system and method for fraud prevention is provided. Specifically, an application program interface may be used in concert with an authorization request to process a transaction, to utilize fraud prevention tools. A system, method and/or computer program product for transmitting an authorization request and a request for fraud services to a transaction account issuer is disclosed. The transaction account issuer may combine the authorization request and request for fraud services in order to create an authorization response.

### CROSS REFERENCE TO RELATED APPLICATIONS

This application is a continuation-in-part of, and claims priority to U.S. application Ser. No. 12/874,063 entitled “Application Program Interface Based Fraud Mitigation” and filed Sep. 1, 2010. The above-listed application is incorporated herein by reference in its entirety.

### FIELD

The present disclosure generally relates to electronic commerce, and more particularly, a system and method of fraud prevention for electronic commerce.

### BACKGROUND

Many merchants employ third party companies to provide value added services in the flow of data between a merchant and a financial institution. These third parties are employed by the merchant to assist with standardizing data elements to be provided to multiple financial institutions, capturing data for analysis for marketing and/or risk management purposes, providing software or hardware to facilitate acceptance of payment products as well as other purposes.

Therefore, if a merchant and a financial institution would like to exchange additional communications or add additional data elements to an existing communication message, software changes and a testing process to determine if the data can accurately and appropriately be transmitted are traditionally implemented by each entity in the payment chain (each third party company). This poses a limitation on the speed and ability for new communications to be rolled-out, limiting the new services and features that can be offered by a financial institution to a merchant.

### SUMMARY

The present disclosure includes a system, method and/or computer program product for transmitting an authorization request and a request for fraud services to a financial institution. The method may include receiving transaction information from an entity, and identifying enhanced authorization data associated with the transaction information. A merchant may create an authorization request and a request for fraud services based on the transaction information and the enhanced authorization data. The authorization request may be transmitted from the merchant to the financial institution through a payment processor or other third party for processing. The request for fraud services may be transmitted to the financial institution over an application program interface and/or via a third party. The request for fraud services may also be transmitted directly to the financial institution over an application program interface without going through a third party. The transaction account issuer may determine that the request for fraud services is associated with the authorization request. The transaction account issuer may use the authorization request and the request for fraud services to create an authorization message. The merchant may receive the authorization message from the transaction account issuer.

### BRIEF DESCRIPTION OF THE DRAWINGS

A more complete understanding may be derived by referring to the detailed description and claims when considered in connection with the Figures, wherein like reference numbers refer to similar elements throughout the Figures, and:

FIG. 1 is a block diagram illustrating a path to transmit and/or receive a transaction authorization request and/or transmit data to be used with a fraud mitigation tool in accordance with an exemplary embodiment;

FIG. 2 is a block diagram illustrating a plurality of parallel paths between a merchant and a transaction account issuer usable to transmit and/or receive a transaction authorization request and/or transmit data to be used with a fraud mitigation tool in accordance with an exemplary embodiment;

FIG. 3 is a block diagram illustrating an application program interface coupled to software of a gateway usable to transmit and/or receive a transaction authorization request and/or transmit data to be used with a fraud mitigation tool in accordance with an exemplary embodiment;

FIG. 4 is a block diagram illustrating an application program interface coupled to software of a vendor usable to transmit and/or receive a transaction authorization request and/or transmit data to be used with a fraud mitigation tool in accordance with an exemplary embodiment;

FIG. 5 is a block diagram illustrating an application program interface coupled to software of a processor usable to transmit and/or receive a transaction authorization request and/or transmit data to be used with a fraud mitigation tool in accordance with an exemplary embodiment;

FIG. 6 is a block diagram illustrating an application program interface directly coupled to merchant computer systems usable to transmit and/or receive a transaction authorization request and/or transmit data to be used with a fraud mitigation tool in accordance with an exemplary embodiment;

FIG. 7 is a block diagram illustrating an application program interface coupled to the software of a merchant, gateway, vendor, processor, and/or transaction account issuer to transmit and/or receive a transaction authorization request and/or transmit data between one or more of the merchant, gateway, vendor, processor, and/or transaction account issuer in accordance with an exemplary embodiment;

FIG. 8 is a flowchart depicting a process for transmitting a request for fraud services according to various embodiments;

FIG. 9 is a flowchart depicting a process for performing risk assessment according to various embodiments;

FIG. 10 illustrates an authorization request and an enhanced authorization queue according to various embodiments; and

FIG. 11 is a block diagram of an exemplary computer based system for implementing portions, in accordance with various embodiments.

### DETAILED DESCRIPTION

The detailed description of exemplary embodiments herein makes reference to the accompanying drawings and pictures, which show the exemplary embodiment by way of illustration. While these exemplary embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

Phrases and terms similar to an “entity” may include any individual, consumer, customer, group, business, organization, government entity, transaction account issuer or processor (e.g., credit, charge, etc), merchant, consortium of merchants, account holder, charitable organization, software, hardware, and/or any other type of entity. The terms “user,” “consumer,” “purchaser,” and/or the plural form of these terms are used interchangeably throughout herein to refer to those persons or entities that are alleged to be authorized to use a transaction account.

Phrases and terms similar to “account”, “account number”, “account code” or “consumer account” as used herein, may include any device, code (e.g., one or more of an authorization/access code, personal identification number (“PIN”), Internet code, other identification code, and/or the like), number, letter, symbol, digital certificate, smart chip, digital signal, analog signal, biometric or other identifier/indicia suitably configured to allow the consumer to access, interact with or communicate with the system. The account number may optionally be located on or associated with a rewards account, charge account, credit account, debit account, prepaid account, telephone card, embossed card, smart card, magnetic stripe card, bar code card, transponder, radio frequency card or an associated account.

The account number may be distributed and stored in any form of plastic, electronic, magnetic, radio frequency, wireless, audio and/or optical device capable of transmitting or downloading data from itself to a second device. A consumer account number may be, for example, a sixteen-digit account number, although each credit provider has its own numbering system, such as the fifteen-digit numbering system used by American Express. Each company's account numbers comply with that company's standardized format such that the company using a fifteen-digit format will generally use three-spaced sets of numbers, as represented by the number “0000 000000 00000”. The first five to seven digits are reserved for processing purposes and identify the issuing bank, account type, etc. In this example, the last (fifteenth) digit is used as a sum check for the fifteen digit number. The intermediary eight-to-eleven digits are used to uniquely identify the consumer. A merchant account number may be, for example, any number or alpha-numeric characters that identify a particular merchant for purposes of account acceptance, account reconciliation, reporting, or the like.

Phrases and terms similar to “transaction account” may include any account that may be used to facilitate a financial transaction.

Phrases and terms similar to “financial institution” or “transaction account issuer” may include any entity that offers transaction account services. Although often referred to as a “financial institution,” the financial institution may represent any type of bank, lender or other type of account issuing institution, such as credit card companies, card sponsoring companies, or third party issuers under contract with financial institutions. It is further noted that other participants may be involved in some phases of the transaction, such as an intermediary settlement institution.

Phrases and terms similar to “business” or “merchant” may be used interchangeably with each other and shall mean any person, entity, distributor system, software and/or hardware that is a provider, broker and/or any other entity in the distribution chain of goods or services. For example, a merchant may be a grocery store, a retail store, a travel agency, a service provider, an on-line merchant or the like.

The terms “payment vehicle,” “financial transaction instrument,” “transaction instrument” and/or the plural form of these terms may be used interchangeably throughout to refer to a financial instrument.

Phrases and terms similar to “merchant,” “supplier” or “seller” may include any entity that receives payment or other consideration. For example, a supplier may request payment for goods sold to a buyer who holds an account with a transaction account issuer.

Phrases and terms similar to a “buyer” may include any entity that receives goods or services in exchange for consideration (e.g. financial payment). For example, a buyer may purchase, lease, rent, barter or otherwise obtain goods from a supplier and pay the supplier using a transaction account.

Phrases and terms similar to an “item” may include any good, service, information, experience or anything of value.

Phrases and terms similar to “internal data” may include any data a credit issuer possesses or acquires pertaining to a particular consumer. Internal data may be gathered before, during, or after a relationship between the credit issuer and the transaction account holder (e.g., the consumer or buyer). Such data may include consumer demographic data. Consumer demographic data includes any data pertaining to a consumer. Consumer demographic data may include consumer name, address, telephone number, email address, employer and social security number. Consumer transactional data is any data pertaining to the particular transactions in which a consumer engages during any given time period. Consumer transactional data may include, for example, transaction amount, transaction time, transaction vendor/merchant, and transaction vendor/merchant location. Transaction vendor/merchant location may contain a high degree of specificity to a vendor/merchant. For example, transaction vendor/merchant location may include a particular gasoline filing station in a particular postal code located at a particular cross section or address. Also, for example, transaction vendor/merchant location may include a particular web address, such as a Uniform Resource Locator (“URL”), an email address and/or an Internet Protocol (“IP”) address for a vendor/merchant. Transaction vendor/merchant, and transaction vendor/merchant location may be associated with a particular consumer and further associated with sets of consumers. Consumer payment data includes any data pertaining to a consumer's history of paying debt obligations. Consumer payment data may include consumer payment dates, payment amounts, balance amount, and credit limit. Internal data may further comprise records of consumer service calls, complaints, requests for credit line increases, questions, and comments. A record of a consumer service call includes, for example, date of call, reason for call, and any transcript or summary of the actual call.

Phrases similar to a “processor” (such as a payment processor) may include a company (e.g., a third party) appointed (e.g., by a merchant) to handle transactions for merchant banks. Payment processors may be broken down into two types: front-end and back-end. Front-end payment processors have connections to various transaction accounts and supply authorization and settlement services to the merchant banks' merchants. Back-end payment processors accept settlements from front-end payment processors and, via The Federal Reserve Bank, move money from an issuing bank to the merchant bank. In an operation that will usually take a few seconds, the payment processor will both check the details received by forwarding the details to the respective account's issuing bank or card association for verification, and may carry out a series of anti-fraud measures against the transaction. Additional parameters, including the account's country of issue and its previous payment history, may be used to gauge the probability of the transaction being approved. In response to the payment processor receiving confirmation that the transaction account details have been verified, the information may be relayed back to the merchant, who will then complete the payment transaction. In response to the verification being denied, the payment processor relays the information to the merchant, who may then decline the transaction.

Phrases similar to a “payment gateway” or “gateway” may include an application service provider service that authorizes payments for e-businesses, online retailers, and/or traditional brick and mortar merchants. The gateway may be the equivalent of a physical point of sale terminal located in most retail outlets. A payment gateway may protect transaction account details by encrypting sensitive information, such as transaction account numbers, to ensure that information passes securely between the customer and the merchant and also between merchant and payment processor.

Phrases similar to “vendor software” or “vendor” may include software, hardware and/or a solution provided from an external vendor (e.g., not part of the merchant) to provide value in the payment process (e.g., risk assessment).

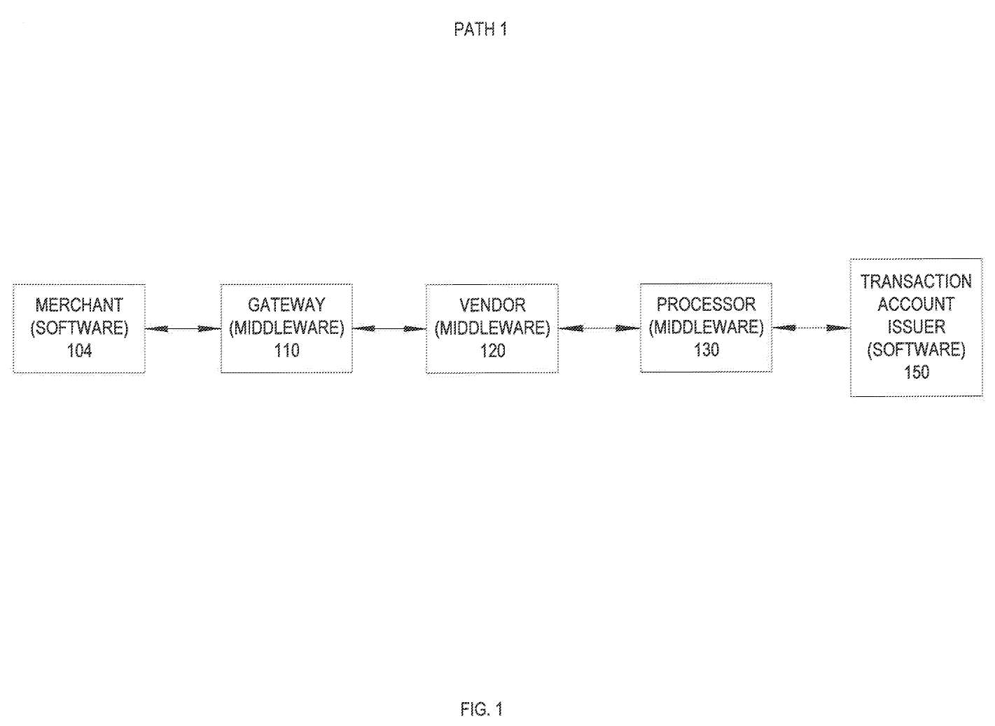

Referring to FIG. 1, various embodiments may include an entity, a merchant 104, an authorization system, and various databases. The authorization system may include gateway 110, vendor 120 and processor 130. The authorization system may send data (such as value added services) to a transaction account issuer 150 and/or financial institution to assist with an authorization decision. The databases may include account holder database and a transaction database. The entity may interact with merchant 104 (e.g., merchant system) to make a purchase using a transaction account. Merchant 104 may request authorization to accept the transaction account and/or transaction instrument as payment by sending a request to the authorization system. This request may be provided to the transaction account issuer 150 through communications path 1. The authorization system may perform risk analysis on the request using information, for example, from the account holder database and the transaction database. Based on the risk analysis, the authorization system may create an authorization decision to approve, deny or refer the request. The authorization decision is provided to merchant 104. This authorization decision may be provided to merchant 104 through communications path 1. Merchant 104 may complete the transaction if the request is approved, verify that the merchant 104 is able to or desires to complete the transaction and/or may ask for an alternative form of payment from the entity if the request is denied. If the request is referred, merchant 104 may contact the transaction account issuer 150 or ask the entity to contact the transaction account issuer 150 to provide additional information to have the request approved.

An entity may interact with merchant 104 in person (e.g., at the box office), telephonically, or electronically (e.g., from a user computer via the Internet) to complete the transaction (e.g. to make a purchase). When interacting in person, an entity may physically present a transaction instrument to merchant 104 as a form of payment. When communicating with merchant 104 through a telephone or a computer (e.g., using a web enabled computer, kiosk, terminal or the like), an entity may provide information associated with a transaction instrument (e.g., transaction account number or code, expiration date, account name, and billing address) to merchant 104 to make a payment.

Along with providing a transaction instrument and/or transaction account information as payment, an entity may provide additional information to merchant 104 in response to conducting a purchase. For example, an entity may provide a ship-to-address or a ship-to-name that may be different than a name or billing address associated with the transaction instrument. An entity may provide an email address or a contact telephone number to merchant 104 so that the entity may be updated with the status of a purchase.

Furthermore, merchant 104 may obtain additional information about an entity from other sources while interacting with the entity. For example, if the entity is communicating with merchant 104 over a telephone, merchant 104 may receive an automatic number identification (ANI) and a corresponding information identifier (II) for the entity from a telephone company. ANI provides the telephone number of the telephone used by the entity to communicate with merchant 104. II identifies the type of telephone used by the entity such as, for example, a cellular telephone, coin-operated telephone, prison telephone, or a standard land-line telephone. In another example, if the entity is communicating with merchant 104 over the Internet, the Internet Protocol (IP) address of the machine that the entity used to initiate the purchase may be captured by whatever Internet-based commerce system utilized by merchant 104. Additionally, information regarding the goods or services purchased may be communicated with the transaction account issuer.

In various embodiments, the merchant 104 may use a software development kit. The software development kit may extract or parse enhanced authorization data obtained by the merchant. The software development kit may transmit the enhanced authorization data to the transaction account issuer 150. In various embodiments, the software development kit may be cached on a web acceleration server. The software development kit may identify the enhanced authorization data obtained by the merchant 104, and transmit the enhanced authorization data to the transaction account issuer 150, bypassing the payment processor 130. The software development kit may create a request for fraud services including the enhanced authorization data and transmit the request for fraud services to the transaction account issuer 150 in response to detecting a payment request. In various embodiments, the request for fraud services is based on information gathered at a point-of-sale device. In various embodiments the request for fraud services is based on information gathered from an on-line transaction.

In various embodiments, in response to determining that the entity desires to make a payment using a transaction account, merchant 104 submits a request to the authorization system to accept the transaction instrument as payment. Merchant 104 may also send a fraud assessment request to capture information about the transaction instrument, payment information, and enhanced authorization data. Examples of enhanced authorization data include, for example, an ANI, an II, an email address, a contact telephone number, a ship-to-name, a ship-to-address, customer hostname, HTTP browser type, ship to country, shipping method, product SKU, number of cities, an IP address, a seller identification, and/or descriptors of goods or services associated with the transaction. The request is transmitted to the authorization system. These requests may be sent to the authorization system and/or transaction account issuer 150 over, for example, a telephone network, intranet, the Internet, wireless communications, application program interface (API) and/or the like. These fraud assessment requests may be sent in parallel with a transaction authorization request, after a transaction authorization request, in response to sending a transaction request, in response to receiving a transaction request response and/or prior to sending an authorization request. Also, a fraud assessment request may be sent from a merchant 104 to as transaction account issuer 150 at any time, with or without an associated accompanying transaction authorization request. Merchant 104 may format the authorization request to include information about the transaction instrument, payment information, and/or enhanced authorization data. Merchant 104 may send information about the transaction instrument, payment information, and/or enhanced authorization data directly to the authorization system and/or account issuer 150. In various embodiments, the software development kit may determine that the entity has requested a purchase, and the software development kit may automatically create a request for fraud services and transmit the request for fraud services to the transaction account issuer 150.

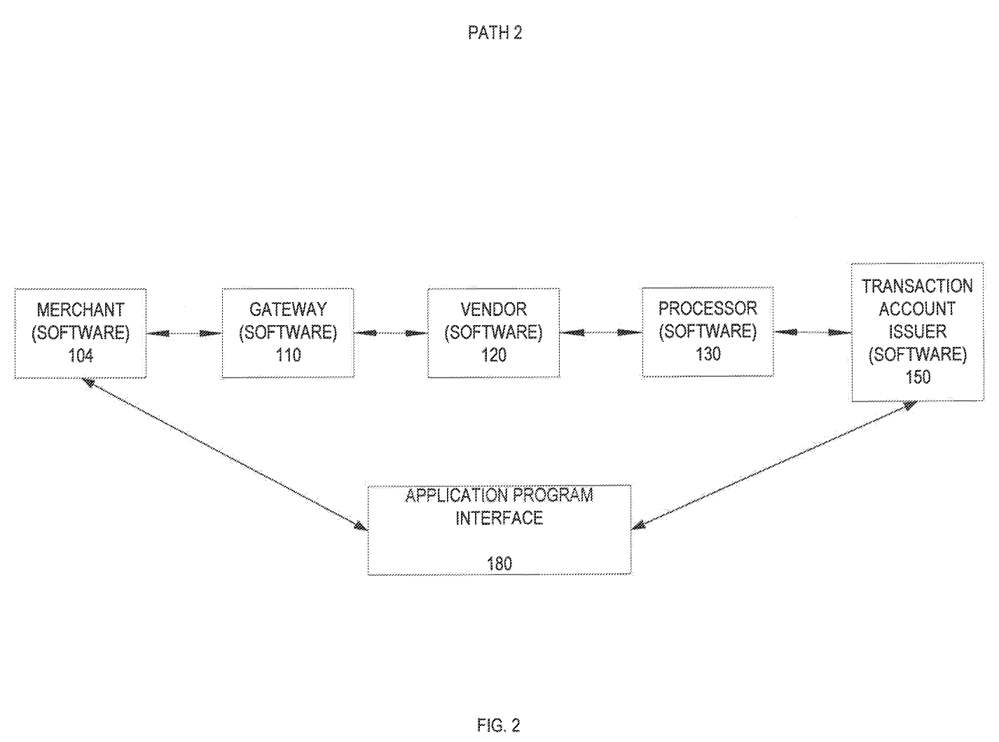

Referring to FIG. 2, in various embodiments a transaction authorization request for a transaction is communicated from merchant 104 to transaction account issuer 150 and/or an authorization system through at least one of gateway 110, vendor 120, or processor 130. Though not depicted, multiple gateways 110, vendors 120 and processors 130 may be utilized in communicating between a merchant 104 and a transaction account issuer 150. Moreover, (though not specifically depicted) one or more gateway 110, vendor 120 and processor 130 may be removed from any communications path described herein. An authorization response may be communicated from the transaction account issuer 150 to the merchant 104 through at least one of processor 130, vendor 120, and/or gateway 110.

A request for fraud services, described in further detail below, to the transaction account issuer may be sent directly through application programming interface (API) 180 to the transaction account issuer 150. A response to the request for fraud services may be sent to the merchant 104 by API 180. In various embodiments, the transaction account issuer 150 combines the request for fraud services and the authorization request and transmits a single authorization response to the merchant 104. In various embodiments, the request for fraud services from the merchant 104 to the transaction account issuer may be sent through, or in combination with utilizing API 180, at least one of gateway 110, vendor 120, and/or processor 130. Also, or in combination with utilizing API 180, the response to the request for fraud services may be communicated from the transaction account issuer 150 to the merchant 104 through at least one of processor 130, vendor 120, and/or gateway 110.

API 180 may be an interface implemented by a software program which enables the API to interact with other software. API 180 may include a programming language that enables communication between computer programs, such as programs of a merchant and programs of a financial institution and/or third party fraud prevention provider programs. API 180 may be implemented by applications, libraries, and operating systems to determine vocabularies and calling conventions, and may be used to access services associated therewith. API 180 may include specifications for routines, data structures, object classes, and protocols for communication. API 180 may describe the ways in which a particular task is performed. API 180 may define a set of request messages, along with a definition of the structure of response messages. API 180 may be a backward compatible API. In some cases API 180 may replace the need for and/or supplement middleware.

API 180 may be used by more than one high-level programming language. Thus, API 180 may facilitate automatically mapping to features (syntactic or semantic). This may be known as language binding, and is itself may be an API. Data fed to API 180 may be automatically captured during the processing of a transaction, entered, and/or provided by a database (e.g., a merchant database, financial institution database and/or third-party database.)

The API may be provided by the financial institution. Access to the API programming may be granted to one or more of the merchant, the financial institution and/or a third party. The API may be provided with or without supporting documentation.

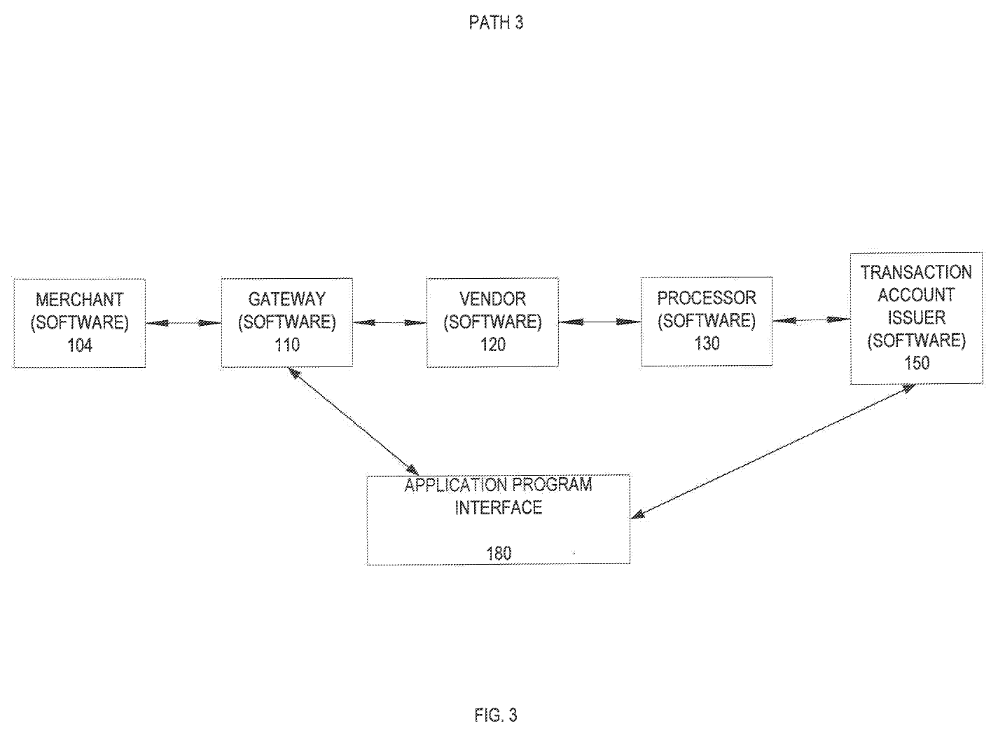

In an embodiment, and with reference to FIG. 3 and path 3, a transaction authorization request and/or request for fraud services is communicated from gateway 110 to transaction account issuer 150 and/or an authorization system by API 180. A response to an authorization request and/or a response to the request for fraud services may be communicated from transaction account issuer 150 and/or an authorization system by API 180 to gateway 110. The authorization request response and/or a response to the request for fraud services may be communicated to merchant 104.

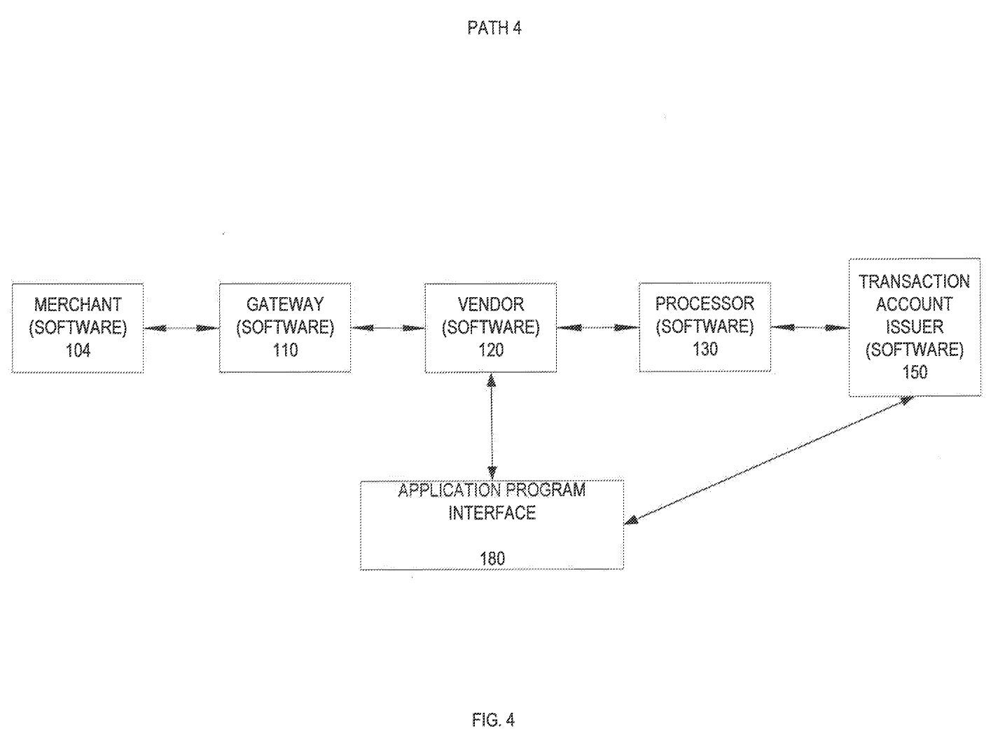

In another embodiment, and with reference to FIG. 4 and path 4, a transaction authorization request and/or request for fraud services is communicated from vendor 120 to transaction account issuer 150 and/or an authorization system through and/or using at least one of vendor 120, and processor 130. It is understood a response to an authorization request and/or a response to the request for fraud services may be communicated from transaction account issuer 150 and/or an authorization system by API 180 to vendor 120. The authorization request response and/or a response to the request for fraud services may be communicated through gateway 110 to merchant 104.

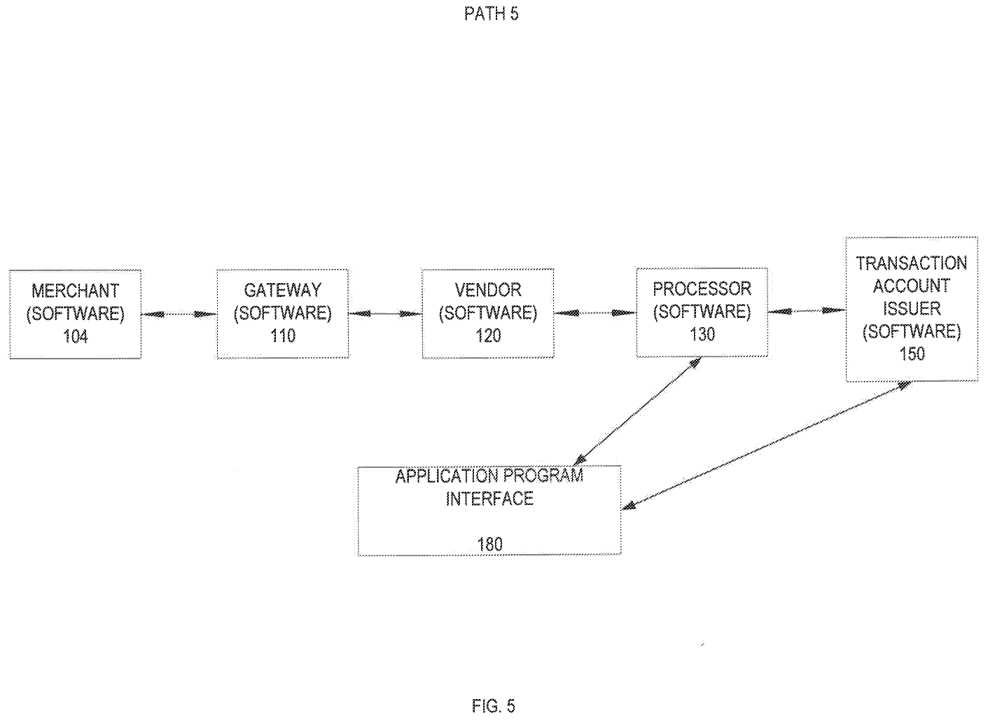

In an embodiment, and with reference to FIG. 5 and path 5, a transaction authorization request and/or request for fraud services is communicated from processor 130 to transaction account issuer 150 and/or an authorization system through and/or using at least one of vendor 120, and processor 130. A response to an authorization request and/or a response to the request for fraud services may be communicated from transaction account issuer 150 and/or an authorization system by API 180 to processor 130. The authorization request response and/or a response to the request for fraud services may be communicated from processor 130 to vendor 120 and gateway 110 to merchant 104.

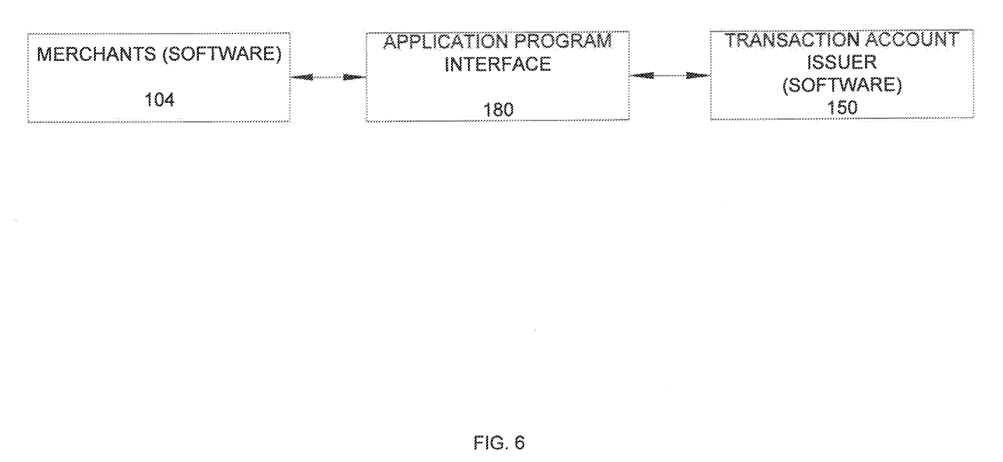

In various embodiments, and with reference to FIG. 6 and path 6, a transaction authorization request and/or request for fraud services may be communicated from merchant 104 to transaction account issuer 150 and/or an authorization system by API 180. As previously mentioned, a communicated request for fraud services may be made in concert with a request for authorization or at any suitable time, such as prior to, during, or after a request for authorization. Also, it is contemplated that a request for fraud services may be made without a request for authorization by API 180.

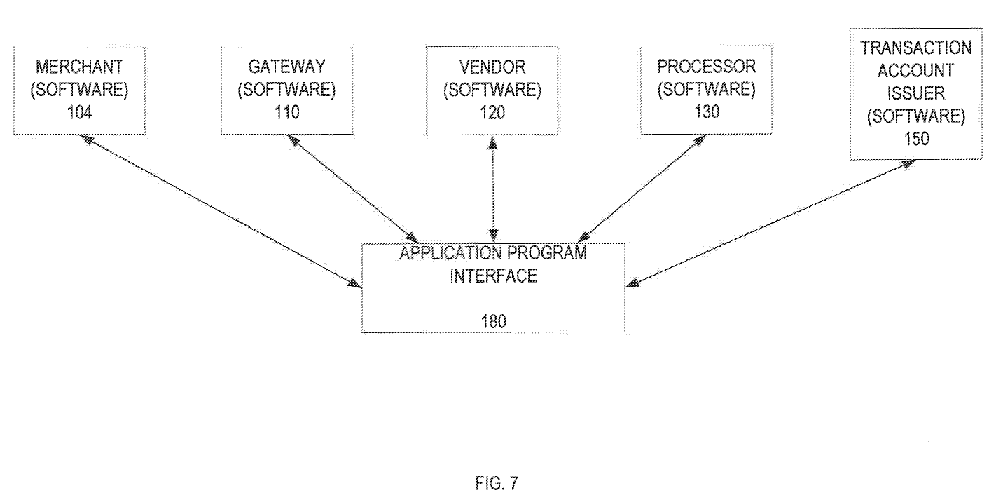

In various embodiments, and with reference to FIG. 7 and path 7, one or more of merchant 104, gateway 110, vendor 120, processor 130 and/or transaction account issuer 150 are interconnected through one or more API (e.g. API 180). Though not every derivation is shown, it is contemplated that merchant 104, gateway 110, vendor 120, processor 130 and transaction account issuer 150, may communicated by API 180 and/or directly to one or more gateway 110, vendor 120, and processor 130.

The terms and phase “a request for fraud services” may be a traditional request. A request for services may also describe sending additional information captured during a transaction which software, hardware, third party, and/or transaction account issuer 150 may use in association with a fraud assessment.

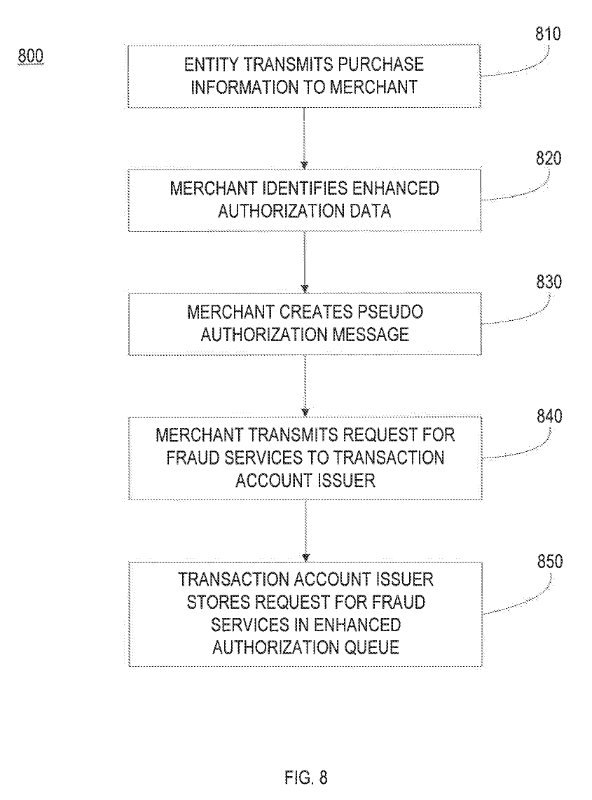

Referring to FIG. 8, a process 800 for transmitting a request for fraud services is illustrated according to various embodiments, in step 810, the entity may transmit the transaction information to the merchant 104. In step 820, the software development kit may identify enhanced authorization data. The merchant 104 may store the data associated with the transaction. The enhanced authorization data may comprise any of the payment information input by the consumer. Additionally, the enhanced authorization data may comprise data captured by the merchant 104. For example, the software development kit may capture an IP address of the entity, a time of the payment request, a merchant identifier number, a customer hostname, HTTP browser type, and/or a description of the goods or services. In various embodiments, the processor 130 may be incapable of receiving, processing, and/or transmitting the enhanced authorization data. The merchant 104 or transaction account issuer 150 may determine that the processor 130 is incapable of receiving, processing, and/or transmitting the enhanced authorization data.

In step 830, the merchant 104 may create a request for fraud services. The request for fraud services may contain some of the same information as the authorization request described with reference to FIG. 1. In various embodiments, the request for fraud services may comprise the transaction account number, the expiration date, and the billing address. However, the request for fraud services may comprise additional data which was not contained in the authorization request. In various embodiments, the request for fraud services may comprise any combination of the transaction information and the enhanced authorization data identified by the merchant 104. In various embodiments the software development kit may append a time stamp to the request for fraud services.

In step 840, the merchant 104 may transmit the request for fraud services to the transaction account issuer 150. In various embodiments, the software development kit automatically creates and transmits the request for fraud services to the transaction account issuer 150. In various embodiments, the request for fraud services bypasses the gateway 110, the vendor 120, and the processor 130. Thus, the processor 130 may not ever need to process or be aware of the request for fraud services. In various embodiments, the request for fraud services is transmitted to the transaction account issuer 150 through the application program interface (API) 180.

In step 850, the transaction account issuer 150 may receive the request for fraud services. In various embodiments, the transaction account issuer 150 may match the request for fraud services with a corresponding authorization request. In various embodiments, the transaction account issuer 150 may store the request for fraud services in an enhanced authorization queue.

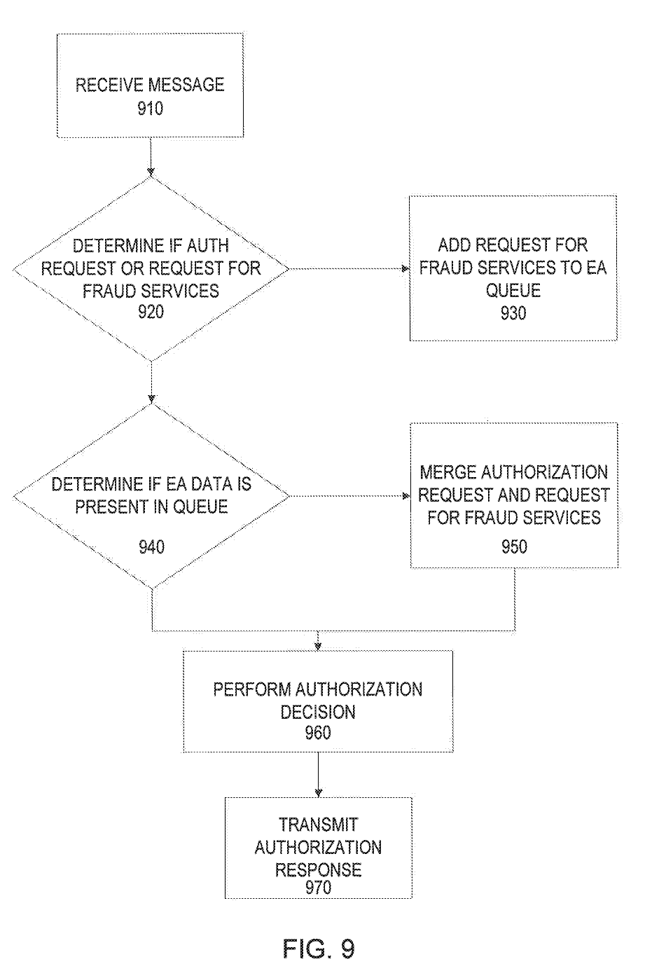

Referring to FIG. 9, a process for performing risk assessment is illustrated according to various embodiments. In step 910, in various embodiments, the transaction account issuer 150 may receive a message. In step 920, the transaction account issuer 150 may determine whether the message is an authorization request or a request for fraud services. In various embodiments, in response to determining that the message is a request for fraud services, the transaction account issuer 150 may store the request for fraud services in an enhanced authorization queue. In various embodiments, in response to determining that the message is a request for fraud services, the transaction account issuer 150 may check for a corresponding authorization request.

In various embodiments, the transaction account issuer 150 may determine that the message is an authorization request. The transaction account issuer 150 may determine whether a merchant associated with the authorization request participates in the digital gateway fraud mitigation system. The transaction account issuer 150 may poll the enhanced authorization queue in order to match a request for fraud services with a corresponding authorization request. The transaction account issuer 150 may not locate a corresponding request for fraud services in the enhanced authorization queue, and the transaction account issuer 150 may proceed to perform an authorization decision based on the information contained in the authorization request.

In various embodiments, the transaction account issuer 150 locates a request for fraud services in the enhanced authorization queue corresponding to the authorization request in step 940. In step 950, the transaction account issuer 150 may merge the authorization request and the request for fraud services in order to create an enhanced authorization message.

In step 960, the transaction account issuer 150 may perform an authorization decision. In various embodiments, the transaction account issuer 150 may compare the data in the enhanced authorization message with data in a risk database. For example, the data in the risk database may indicate that the IP address associated with the enhanced authorization message has been used to commit fraud in the past. In various embodiments, the risk database may contain data associated with any of the information in the enhanced authorization message indicating positive or negative fraud risks associated with the transaction. The transaction account issuer 150 may use the information in the risk database in determining whether to approve or decline the authorization request.

In step 970, the transaction account issuer 150 may transmit an authorization response indicating an approval. or denial of the authorization request. In various embodiments the authorization response is transmitted to the merchant 104 through at least one of the gateway 110, vendor 120, or processor 130. The merchant 104 may transmit an approval or denial message to the entity. In various embodiments, the transaction account issuer may transmit separate authorization responses to the merchant 104 and the entity. The authorization response may be received by a hardware component on a device of the entity. Hardware components may include personal computers, mobile phones, tablet devices, or any other device capable of communicating with a network.

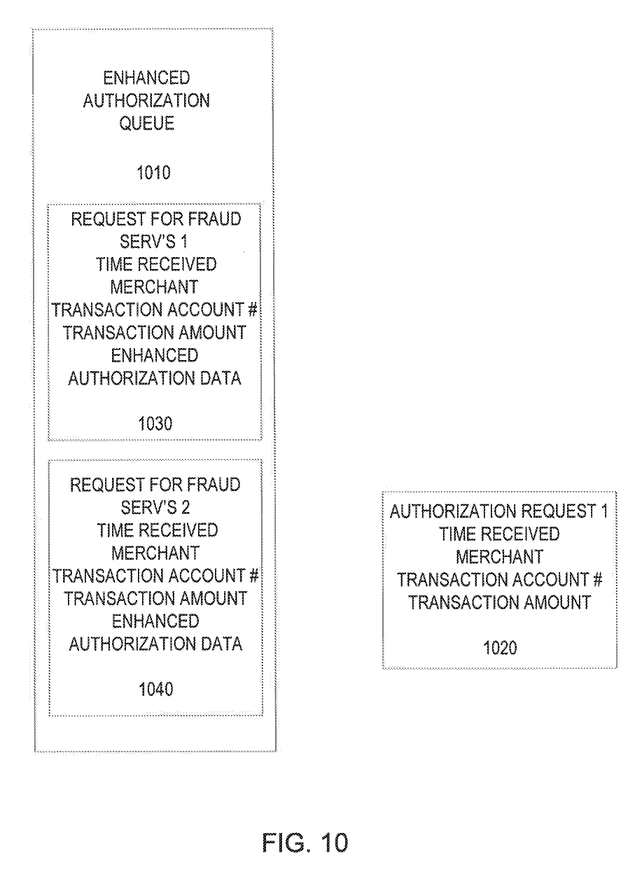

Referring to FIG. 10, an example of matching an authorization request to a request for fraud services is illustrated according to various embodiments. Transaction account issuer 150 may poll enhanced authorization queue 1010 for a request for fraud services corresponding to authorization request 1020. In various embodiments, the transaction account issuer 150 may compare fields such as time received, a merchant associated with the message, a transaction account number or a transaction amount of the authorization request with similar fields of a request for fraud services in the enhanced authorization queue 1010. Transaction account issuer 150 may compare any data associated with the authorization request with data in the request for fraud services. For example, transaction account issuer 150 may determine that the time received of authorization request 1020 is not within a specified amount of the time received of request for fraud services 1030 and determine that request for fraud services 1030 does not correspond to authorization request 1020. Transaction account issuer 150 may determine that the data associated with authorization request 1020 is sufficiently similar to the data associated with request for fraud services 1040 and determine that authorization request 1020 and request for fraud services 1040 correspond to the same transaction. Transaction account issuer 150 may merge the data of authorization request 1020 and request for fraud services 1040 to create an enhanced authorization message. Transaction account issuer 150 may use the enhanced authorization message to determine whether to approve or deny the authorization request. In various embodiments transaction account issuer 150 may remove the enhanced data prior to transmitting an authorization response to the merchant 104.

In various embodiments, a request for fraud services may include transmitting enhanced authorization data and/or utilizing fraud tools and/or customer level data as disclosed in pending U.S. patent application Ser. No. 13/411,299, entitled “SYSTEMS AND METHODS FOR ENHANCED AUTHORIZATION FRAUD MITIGATION,” filed Mar. 2, 2012; U.S. patent application Ser. No. 11/303,018, entitled “SYSTEM, METHOD AND COMPUTER PROGRAM PRODUCT FOR AUTHORIZING TRANSACTIONS USING ENHANCED AUTHORIZATION DATA,” filed Dec. 16, 2005; U.S. application Ser. No. 10/588,811, entitled “SYSTEM AND METHOD USING ENHANCED AUTHORIZATION DATA TO REDUCE TRAVEL RELATED TRANSACTION FRAUD,” filed Jun. 11, 2007; and U.S. application Ser. No. 12/205,412, entitled “METHOD, SYSTEM, AND COMPUTER PROGRAM PRODUCT FOR CUSTOMER-LEVEL DATA VERIFICATION,” filed Sep. 5, 2008, the contents of all documents are hereby incorporated by reference for any purpose. in their entirety. For instance, a fraud mitigation tool and/or request for fraud services may include a data element (i.e. information that may be known by a financial transaction instrument issuer and/or the customer having a financial transaction instrument issued by the financial transaction instrument issuer as the enhanced authorization data, such as a whole or partial national identification number and/or whole or partial date of birth).

In various embodiments, a fraud mitigation tool and/or request for fraud services may include receiving enhanced authorization data. This enhanced authorization data may be sent in concert with an authorization request in an appended authorization request and/or in a separate request by an API such as API 180. The enhanced authorization data may include at least one of an automatic number identification and an information identifier. The enhanced authorization data may include at least one of an email address; a contact telephone number; a ship-to-name; a ship-to-address; an Internet Protocol (IP) address; and/or seller identification. information. The enhanced authorization data may include at least one of an entity name; passenger name; a national identification code associated with a particular country (such as a social security number), date of birth, a travel date; a routing description; an electronic ticket indicator; an origin city; a destination city; a class of service; a number of passengers; a reservation code; and/or carrier code. The enhanced authorization data may be provided in whole or in part, for instance providing only the last four digits of a social security number. In various embodiments, when a partial enhanced authorization data entry is provided, a computer based system may compare the partial entry against a database record for the associated entity and retrieve the complete enhanced authorization data record.

In an embodiment, a fraud mitigation tool and/or request for fraud services may include receiving (from the merchant for use in real-time authorization) transaction variables for a transaction involving a purchase of a travel ticket using the financial account such as by API 180. The transaction variables may include at least one of a passenger name on the travel ticket, a travel date, a routing description of the travel ticket, and/or an electronic ticket indicator; and processing the transaction variables through a fraud-risk model to determine a risk factor for the transaction. The transaction authorization request may be approved based on the risk factor being within a range of acceptable values. A purchasing history of the account holder may be retrieved from a database. The transaction authorization request may be approved based on the risk factor and the purchasing history. In various embodiments, a status of the transaction account may be retrieved. The transaction authorization request may be approved based on the risk factor and the status. The transaction authorization request may be declined in response to the risk factor being within a range of unacceptable values.

In an embodiment, the fraud mitigation tool and/or request for fraud services may include receiving a first data element including first transaction account data identifying a first transaction account, and receiving a second data element. An entity may be determined from the first transaction account data. A second transaction account associated with the entity may be identified. A determination that the second data element does not match a corresponding data element associated with the first transaction account may be made. The second data element may be compared with an entity record including second transaction account data identifying the second transaction account. The second transaction account data may be compared with the first transaction account data. A comparison result may be generated to verify the first data element based on the comparing. The comparison result may indicate that the entity is associated with an account corresponding to the first transaction account.

In another embodiment, this request for fraud services may include transmitting information associated with products involved with the transaction to identify risk associated. with the transaction as disclosed in pending U.S. patent application Ser. No. 12/416,675, entitled “AUTHORIZATION REQUEST FOR FINANCIAL TRANSACTIONS,” filed Apr. 1, 2009; the contents of which are hereby incorporated by reference for any purpose in their entirety. For instance, a fraud mitigation tool and/or request for fraud services may include automatically identifying at least one product from a purchase order associated with the transaction, the identification being performed based on an electronic comparison between a predefined list of products and the purchase order. A fraud mitigation tool and/or request for fraud services may include sending product details of the product through a third party (such as with an authorization request) and/or by API 180 to the financial institution. In this embodiment a notification may be received from the financial institution, by API 180 and/or through a third party, wherein the notification includes an authorization decision based on the product details. In this embodiment, the predefined list of products may be defined by the financial institution and/or transaction account issuer 150. The predefined list of products may be defined based on financial risk associated with a plurality of products. A unique code may be associated with each product in the predefined list of products. The unique code associated may be defined by the financial institution and/or transaction account issuer 150 and may be included as a field in the electronic transaction authorization request and/or sent separately by API 180.

In another embodiment, a request for fraud services may include transmitting a post-authorization message for a financial transaction as disclosed in pending U.S. patent application Ser. No. 12/416,680, entitled “POST-AUTHORIZATION MESSAGE FOR A FINANCIAL TRANSACTION,” filed Apr. 1, 2009 the contents of which are hereby incorporated by reference for any purpose in their entirety. For instance, a post-authorization message may be sent from a merchant 104 to a transaction account issuer directly by API 180 or through one or more of a gateway 110, vendor 120 and/or processor 130 coupled to API 180. For instance, post authorization data may be electronically transmitted through at least one of a third party or an application program interface. In this embodiment, an assessment of the feasibility of the financial transaction may be made, such as by the merchant. The financial transaction is processed based at least in part on the feasibility assessment. The financial institution and/or transaction account issuer 150 is provided with an electronic post-authorization message through a third party and/or by an API. The electronic post-authorization message may comprise details related to the processing of the financial transaction including information related to the feasibility assessment.

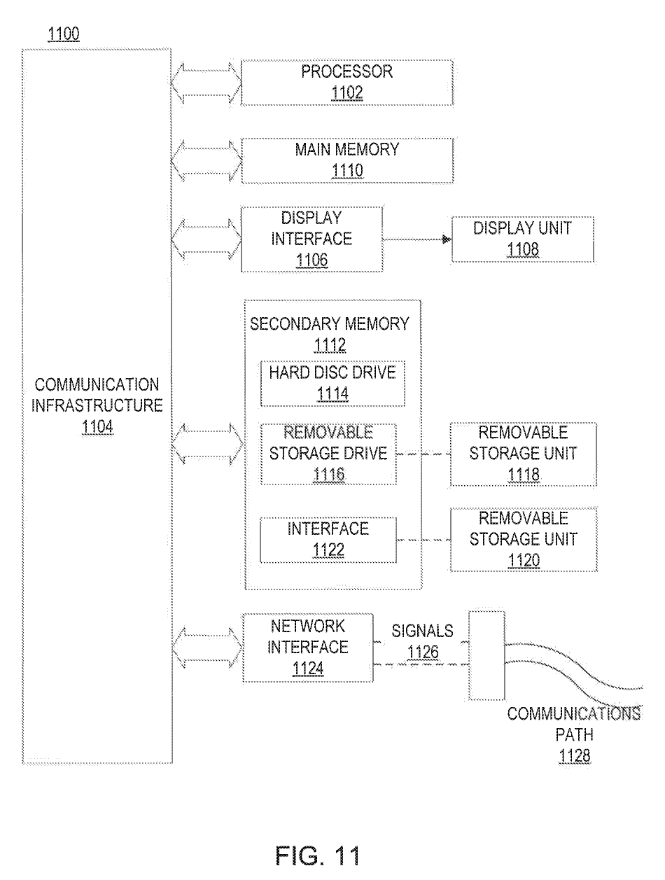

In various embodiments, the invention is directed toward one or more computer systems capable of carrying out the functionality described herein. An example of a computer system 1100 is shown in FIG. 11.

Computer system 1100 includes one or more processors 1102. Processor 1102 is connected to a communication infrastructure 1104 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures. Computer system 1100 can include a display interface 1106 that forwards graphics, text, and other data from communication infrastructure 1104 (or from a frame buffer not shown) for display on display unit 1108.

Computer system 1100 also includes a main memory 1110, preferably random access memory (RAM), and may also include a secondary memory 1112. Secondary memory 1112 may include, for example, a hard disk drive 1114 and/or a removable storage drive 1116, representing a floppy disk drive, a magnetic tape drive, an optical disk drive, an information storage device, etc. Removable storage drive 1116 reads from and/or writes to a removable storage unit 1118. Removable storage unit 1118 represents a floppy disk, a magnetic tape, an optical disk, etc. which is read by, and written to, by removable storage drive 1116. Removable storage unit 1118 includes a computer usable. storage medium having stored therein computer software and/or data.

In alternative embodiments, secondary memory 1112 may include other similar devices for allowing computer programs or other instructions to be loaded into computer system 1100. Such devices may include, for example, removable storage unit 1118, 1120 and an interface 1122. Examples of secondary memory 1112 include a program cartridge and cartridge interface, a removable memory chip (such as an erasable programmable read only memory (EPROM), and/or programmable read only memory (PROM)) with an associated socket, and removable storage unit 1118, 1120 and/or interface 1122, which allow software and data to be transferred from removable storage unit 1118, 1120 to computer system 1100.

Computer system 1100 may also include a communications interface, such as a network interface 1124. Network interface 1124 allows software and data to be transferred between computer system 1100 and an external device. Examples of communications interface may include a modem, a network interface (such as an Ethernet card), a communications port, a Personal Computer Memory Card International Association (PCMCIA) slot and card, etc. Software and data transferred via the communications interface are in the form of signals 1126 which may be electronic, electromagnetic, optical or other signals capable of being received by the communications interface. These signals are provided to the communications interface via a communications path (e.g., channel) 1128. Communications path 1128 carries signals 1126 and may be implemented using wire or cable, fiber optics, a telephone line, a cellular link, a radio frequency (RF) link, and/or other communications channels.

In this document, the terms “computer program medium” and “computer usable medium” are used to generally refer to media such as removable storage drive such as a hard disk installed in hard disk drive 1114, and signals 1126. These computer program products provide software to computer system 1100. The invention is directed to such computer program products.

Computer programs (also referred to as computer control logic) are stored in main memory 1110 and/or secondary memory 1112. Computer programs may also be received via the communications interface. Such computer programs, when executed, enable computer system 1100 to perform the features, as discussed herein. In particular, the computer programs, when executed, enable processor 1102 to perform the features. Accordingly, such computer programs represent controllers of computer system 1100.

in an embodiment where the invention is implemented using software, the software may be stored in a computer program product and loaded into computer system 1100 using removable storage drive 1116, hard drive 1114 or network interface 1124. The control logic (software), when executed by processor 1102, causes processor 1102 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

One skilled in the art will also appreciate that, for security reasons, any databases, systems, devices, servers or other components described herein may consist of any combination thereof at a single location or at multiple locations, wherein each database or system described herein includes any of various suitable security features, such as firewalls, access codes, encryption, decryption, compression, decompression, and/or the like.

In addition to those described above, the various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation. As those skilled in the art will appreciate, user computer may include an operating system (e.g., Windows NT, 95/98/2000, OS2, UNIX, Linux, Solaris, MacOS, etc.) as well as various conventional support software and drivers typically associated with computers. The computer may include any suitable personal computer, network computer, workstation, minicomputer, mainframe or the like. User computer can be in a home or business environment with access to a network. In an exemplary embodiment, access is through a network or the Internet through a commercially-available web-browser software package.

In various embodiments, components, modules, and/or engines may be implemented as micro-applications or micro-apps. Micro-apps are typically deployed in the context of a mobile operating system, including for example, a Palm mobile operating system, a Windows mobile operating system, an Android Operating System, Apple iOS, a Blackberry operating system and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

As used herein, the term “network” shall include any electronic communications means which orates both hardware and software components of such. Communication among the parties in accordance with the present invention may be accomplished through any suitable communication channels, such as, for example, a telephone network, an extranet, an intranet, Internet, point of interaction device (point of sale device, personal digital assistant, cellular phone, kiosk, etc.), online communications, satellite communications, off-line communications, wireless communications, transponder communications, local area network (LAN), wide area network (WAN), networked or linked devices, keyboard, mouse and/or any suitable communication or data input modality. Moreover, although the invention is frequently described herein as being implemented with TCP/IP communications protocols, the invention may also be implemented using IPX, Appletalk, IP-6, NetBIOS, OSI or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, Dilip Naik, Internet Standards And Protocols (1998); Java 2 Complete, various authors, (Sybex 1999); Deborah Ray And Eric Ray, Mastering Html 4.0 (1997); and Loshin, TCP/IP Clearly Explained (1997) and David Gourley and Brian Totty, HTTP, The Definitive Guide (2002), the contents of which are hereby incorporated by reference.

The invention may be described herein in terms of functional block components, screen shots, optional selections and various processing steps. It should be appreciated that such functional blocks may be realized by any number of hardware and/or software components configured to perform the specified functions. For example, various integrated circuit components, e.g., memory elements, processing elements, logic elements, look-up tables, and/or the like may be included, which may carry out a variety of functions under the control of one or more microprocessors or other control devices. Similarly, any software elements may be implemented with any programming or scripting language such as C, C++, Java, COBOL, assembler, PERL, Visual Basic, SQL Stored Procedures, extensible markup language (XML), with the various algorithms being implemented with any combination of data structures, objects, processes, routines or other programming elements. Further, it should be noted any number of conventional techniques for data transmission, signaling, data processing, network control, and/or the like may be employed with the present system and method. Still further, detection or prevention of security issues with a client-side scripting language, such as JavaScript, VBScript or the like is contemplated with the present system and method. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

These software elements may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a non-transitory computer readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, may be implemented by either special purpose hardware-based computer systems which perform the specified functions or steps, or suitable combinations of special purpose hardware and computer instructions. Further, illustrations of the process flows and the descriptions thereof may make reference to user windows, web pages, web sites, web forms, prompts, etc. Practitioners will appreciate that the illustrated steps described herein may comprise in any number of configurations including the use of windows, web pages, web forms, popup windows, prompts and/or the like. It should be further appreciated that the multiple steps as illustrated and described may be combined into single web pages and/or windows but have been expanded for the sake of simplicity. In other cases, steps illustrated and described as single process steps may be separated into multiple web pages and/or windows but have been combined for simplicity.

Practitioners will appreciate that there are a number of methods for displaying data within a browser-based document. Data may be represented as standard text or within a fixed list, scrollable list, drop-down list, editable text field, fixed text field, pop-up window, and/or the like. Likewise, there are a number of methods available for modifying data in a web page such as, for example, free text entry using a keyboard, selection of menu items, check boxes, option boxes, and/or the like.

Systems, methods and computer program products for fraud prevention and implementing fraud prevention are provided, in the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. After reading the description, it will be apparent to one skilled in the relevant art(s) how to implement the disclosure in alternative embodiments.

In various embodiments, the methods described herein are implemented using the various particular machines described herein. The methods described herein may be implemented using the above particular machines, and those hereinafter developed, in any suitable combination, as would be appreciated immediately by one skilled in the art. Further, as is unambiguous from this disclosure, the methods described herein may result in various transformations of certain articles.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the invention. The scope of the invention is accordingly to be limited by nothing other than the appended claims, in which reference to an element in the singular is not intended to mean “one and only one” unless explicitly so stated, but rather “one or more.” Moreover, where a phrase similar to ‘at least one of A, B, and/or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. All structural, chemical, and functional equivalents to the elements of the above-described exemplary embodiments that are known to those of ordinary skill in the art are expressly incorporated herein by reference and are intended to be encompassed by the present claims. Further, a list of elements does not include only those elements but may include other elements not expressly listed or inherent to such process, method, article, or apparatus.

What is claimed is:

1. A computer-implemented method comprising:
identifying, by a computer-based system for authorizing transaction requests, enhanced authorization data associated with transaction information;
creating, by the computer-based system, an authorization request based on the transaction information;
creating, by the computer-based system, a request for fraud services based on the enhanced authorization data;
transmitting, by the computer-based system, the authorization request to a transaction account issuer via a payment processor; and
transmitting, by the computer-based system, the request for fraud services to a transaction account issuer.

2. The method of claim 1, wherein the request for fraud services bypasses the payment processor.

3. The method of claim 1, wherein the transmitting the request for fraud services occurs in response to the receiving transaction information from the entity.

4. The method of claim 1, wherein the transaction account issuer merges the request for fraud services and the authorization request.

5. The method of claim 1, wherein the request for fraud services is created by a software development kit.

6. The method of claim 1, further comprising separating, by the computer-based system, the enhanced authorization data from the transaction information.

7. The method of claim 1, wherein the request for fraud services comprises a combination of the transaction information and the enhanced authorization data.

8. The method of claim 1, wherein the request for fraud services is transmitted to the transaction account issuer through an application program interface.

9. The method of claim 1, wherein the request for fraud services comprises the enhanced authorization data not included in the transaction information.

10. The method of claim 1, further comprising receiving, by the computer-based system, an authorization response.

11. The method of claim 10, wherein the authorization response is based on the authorization request and the request for fraud services.

12. The method of claim 1, further comprising determining, by the computer-based system, that transaction data within a data stream is associated with a transaction.

13. The method of claim 12, further comprising storing, by the computer-based system, the transaction data associated with the transaction.

14. The method of claim 1, wherein the request for fraud services comprises at least one of a transaction account number, a transaction account issuer, an expiration date, a security code, a billing address, a consumer name, a consumer birth date, a shipping address, a ship-to-name, a shipping method, an email address, a telephone number, an IP address, a service establishment number, a time of the payment request, a customer hostname, an HTTP browser type, and a description of the goods.

15. The method of claim 1, wherein the transaction account issuer determines that the authorization request corresponds to the request for fraud services.

16. The method of claim 1, further comprising determining, by the computer-based system, that the payment processor is incapable of processing the enhanced authorization data.

17. The method of claim 1, further comprising appending, by the computer-based system, a time stamp to the request for fraud services.

18. The method of claim 1, wherein the request for fraud services is transmitted directly to the transaction account issuer.

19. An article of manufacture including a non-transitory, tangible computer readable storage medium having instructions stored thereon that, in response to execution by a computer-based system for authorizing transaction requests, cause the computer-based system to perform operations comprising:
identifying, by the computer-based system, enhanced authorization data associated with transaction information;
creating, by the computer-based system, an authorization request based on the transaction information;
creating, by the computer-based system, a request for fraud services based on the enhanced authorization data;
transmitting, by the computer-based system, the authorization request to a transaction account issuer via a payment processor; and
transmitting, by the computer-based system, the request for fraud services to a transaction account issuer.

20. A system comprising:
a processor for authorizing transaction requests,
a tangible, non-transitory memory configured to communicate with the processor,
the tangible, non-transitory memory having instructions stored thereon that, in response to execution by the processor, cause the processor to perform operations comprising:
identifying, by the processor, enhanced authorization data associated with transaction information;
creating, by the processor, an authorization request based on the transaction information;
creating, by the processor, a request for fraud services based on the enhanced authorization on data;
transmitting, by the processor, the authorization request to a transaction account issuer via a payment processor; and
transmitting, by the processor, the request for fraud services to a transaction account issuer.
